(19) United States
(12) Patent Application Publication
(10) Pub. No.: US 2006/0232980 A1
(43) Pub. Date: Oct. 19, 2006

(54) Structure of a light and sign assembly for showing the direction of an emergency exit

(76) Inventors: Wen-Shou Wang, Tainan City (TW); Yu Pin Kao, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/128,205

(22) Filed: May 13, 2005

(30) Foreign Application Priority Data
Apr. 19, 2005 (TW) 094206090

(51) Int. Cl. B60Q 1/00

(52) U.S. Cl. 362/368

(57) ABSTRACT

A light and sign assembly includes a housing, a lamp, a locating member, and a sign panel; the housing has an opening, and a fitting part therein, which is next to the opening; the sign panel is joined to the lower side of the housing; the lamp is held in the housing, and light from the lamp will travel to the sign panel; a first terminal is secured in the fitting part of the housing and connected to the lamp; the locating member secured in a building, and has a fitting bar portion having a second terminal secured thereto; thus, the first and the second terminals will be connected for connecting the lamp to the main supply of electricity when the housing is fitted on the fitting bar portion of the locating member at the opening and the fitting part thereof.

### BACKGROUND OF THE INVENTION

1. Field of the Invention

The present invention relates to a light and sign assembly for showing the direction of an emergency exit, more particularly one, which is structured in such as way that it takes less time and is easier to install and assemble.

2. Brief Description of the Prior Art

Large buildings, e.g. department stores, and cinemas, have light and sign assemblies for showing the direction of emergency exits such that people can find the emergency exits easily should there be an emergency such as fire, earthquake, and power failure.

A conventional light and sign assembly includes a locating member, a housing member, a lamp, and a sign panel, which is pervasive to light, and which has figures and arrows thereon for showing the direction of an emergency exit. The locating member is secured near to a roof of a building. The sign panel is joined to the housing member, and the lamp is held in the housing member such that light from the lamp will travel through the sign panel to make the figures and the arrows on the sign panel clearly visible. The housing member is joined to the locating member to hold the sign panel in place.

However, the above conventional light and sign assembly takes much time and labor, and isn't easy to install and assemble. In installation and assembling, the worker first has to secure the locating member in position, and pass wires through the locating member. Then, he has to connect the wires to the lamp in the housing member while propping the housing member; the housing member is likely to fall down, and get damaged during this process. Finally, he has to join the housing member to the locating member such that the housing member and the sign panel are firmly held in position.

### SUMMARY OF THE INVENTION

It is a main object of the invention to provide an improvement on a light and sign assembly for showing the direction of an emergency exit to overcome the above-mentioned problem. The light and sign assembly of the invention includes a housing, a lamp, a locating member, and a sign panel. The housing has an opening, and a fitting part therein, which is next to the opening. The sign panel is joined to the lower side of the housing. The lamp is held in the housing, and light from the lamp will travel to the sign panel. A first terminal is secured in the fitting part of the housing and connected to the lamp. The locating member secured in a building, and has a fitting bar portion having a second terminal secured thereto. The first and the second terminals will be automatically connected for connecting the lamp to the main supply of electricity as soon as the housing is fitted on the fitting bar portion of the locating member at the opening and the fitting part thereof.

### BRIEF DESCRIPTION OF THE DRAWINGS

The present invention will be better understood by referring to the accompanying drawings, wherein:

FIG. 1 is a perspective view of the first preferred embodiment of a light and sign assembly in the present invention,

FIG. 2 is a front view of the first preferred embodiment,

FIG. 3 is a horizontal sectional view of the first embodiment before assembly,

FIG. 4 is a partial vertical sectional view of the first embodiment,

FIG. 5 is another perspective view of the first embodiment,

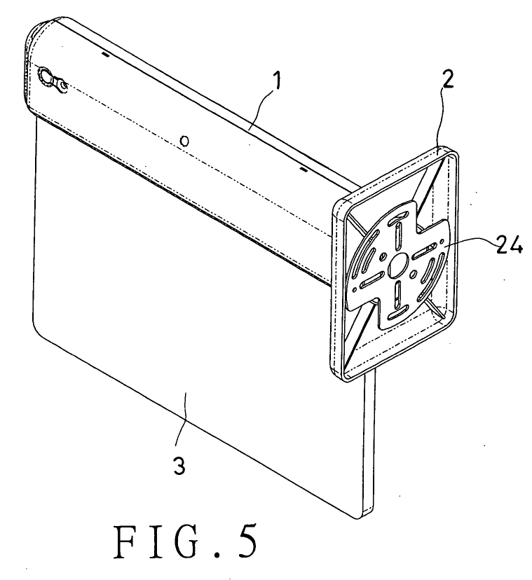

FIG. 6 is a horizontal sectional view of the first embodiment after assembly,

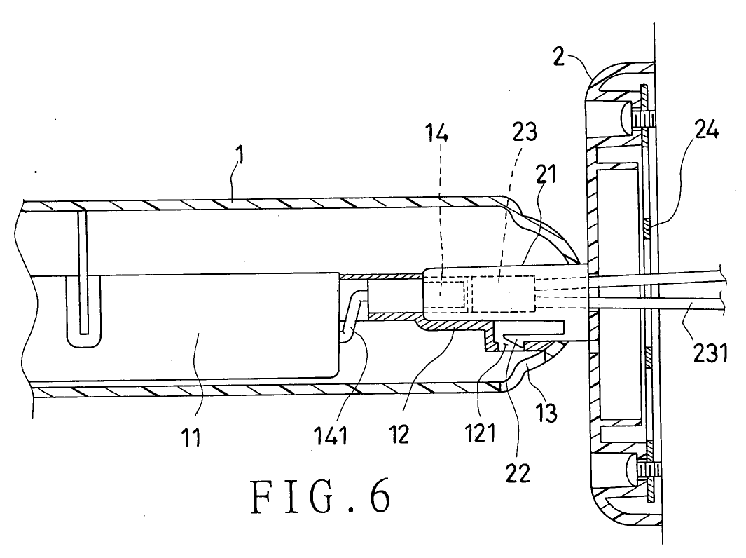

FIG. 7 is a front view of the second preferred embodiment of a light and sign assembly in the present invention,

FIG. 8 is a perspective view of the third preferred embodiment of a light and sign assembly in the present invention, and

FIG. 9 is a front view of the third preferred embodiment.

### DETAILED DESCRIPTION OF THE PREFERRED EMBODIMENTS

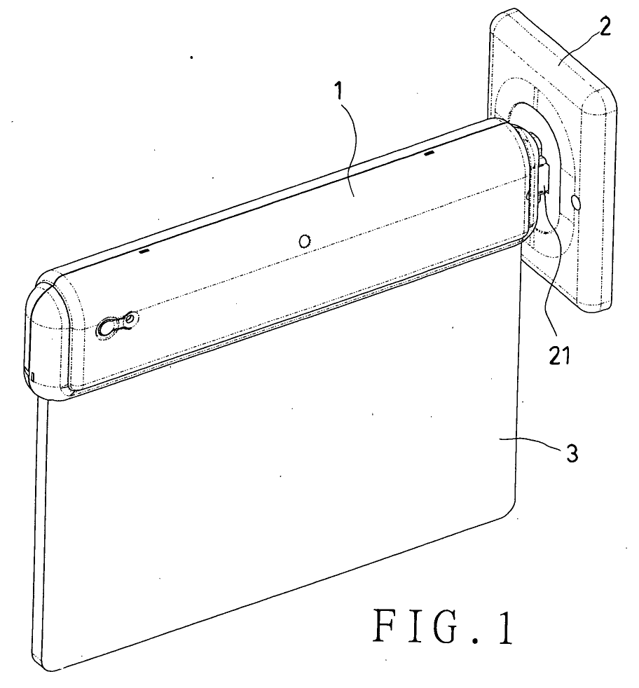

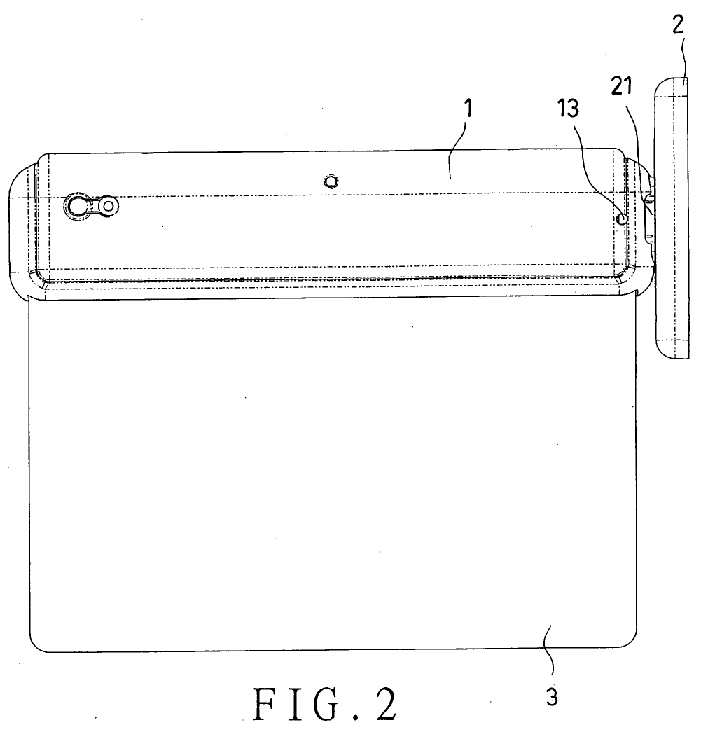

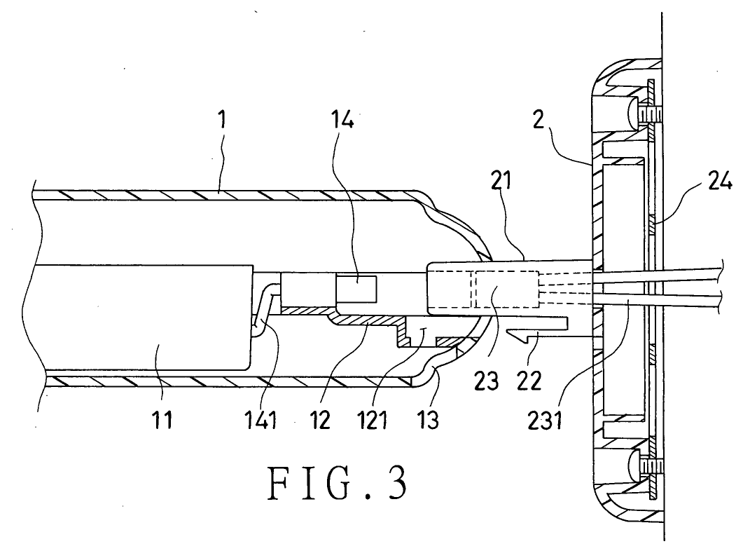

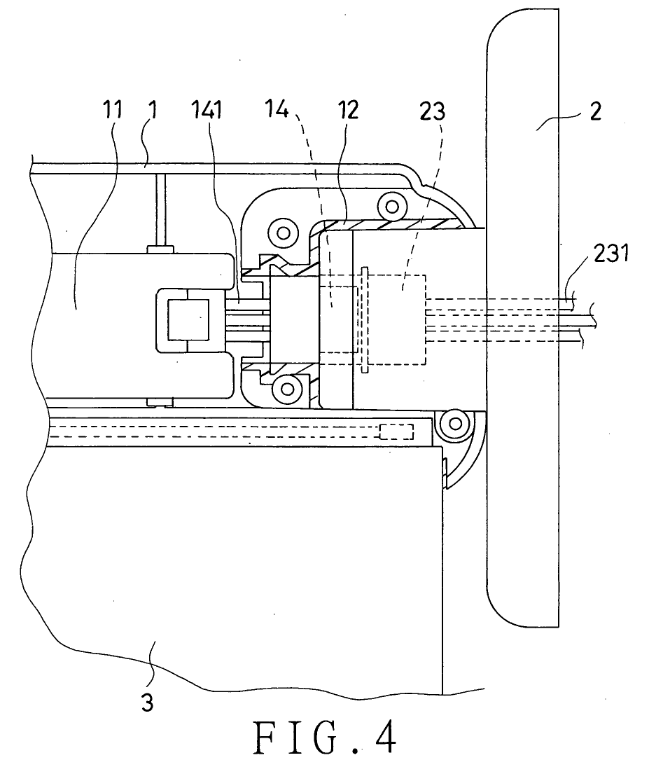

Referring to FIGS. 1 to 4, a first preferred embodiment of a light and sign assembly for showing the direction of an emergency exit includes a housing member 1, a locating member 2, a sign panel 3, and a lamp 11.

The housing member 1 has a first opening on a lower side, and a second opening on a right end thereof. The lamp 11 is held in the housing member 1 such that light from the lamp 11 will travel through the first opening of the housing member 1. Furthermore, the housing member 1 has a through hole 13, and a fitting part 12 securely held therein, which is next to the second opening of the right end of the housing member 1, and which has an engaging hole 121 facing the through hole 13. A terminal 14 is secured in the fitting part 12 of the housing member 1, and several wires 141 are connected to both the lamp 11 and the terminal 14.

The locating member 2 has a hollow fitting bar portion 21, a hooked portion 22 on the hollow fitting bar portion 21, and a terminal 23 in the hollow fitting bar portion 21. Furthermore, a connecting plate 24 is secured on the locating member 2, and wires 231 are connected to the terminal 23, and passed through the connecting plate 24.

The sign panel 3 is pervasive to light, and has figures and an arrow thereon for showing the direction of the emergency exit. The sign panel 3 is joined to the lower side of the housing member 1.

To install and assemble the light and sign assembly of the present invention, first the wires 231 are connected to the main supply of electricity, and the locating member 2 is secured on a wall at the connecting plate 24. Then, the housing member 1 is fitted on the hollow fitting bar portion 21 of the locating member 2 at the second opening and the fitting part 12 thereof with the hooked portion 22 of the hollow fitting bar portion 21 being passed through the engaging hole 121 to engage the fitting part 12. Thus, the housing member 1 and the sign panel 3 are firmly held in position, and both the terminals 14 and 23 are connected to connect the lamp 11 to the main supply of electricity. Consequently, the lamp 11 is powered to produce light, which will through the sign panel 3 to make the figures and the arrow on the sign panel 3 clearly visible.

To separate the housing member 1 from the locating member 1, one should first pass a stick-shaped tool through the through hole 13 of the housing member 1, and press the hooked portion 22 of the locating member 2 with the stick-shaped tool so as to disengage the hooked portion 22 from the fitting part 12; thus, the housing member 1 can be moved away from the locating member 1.

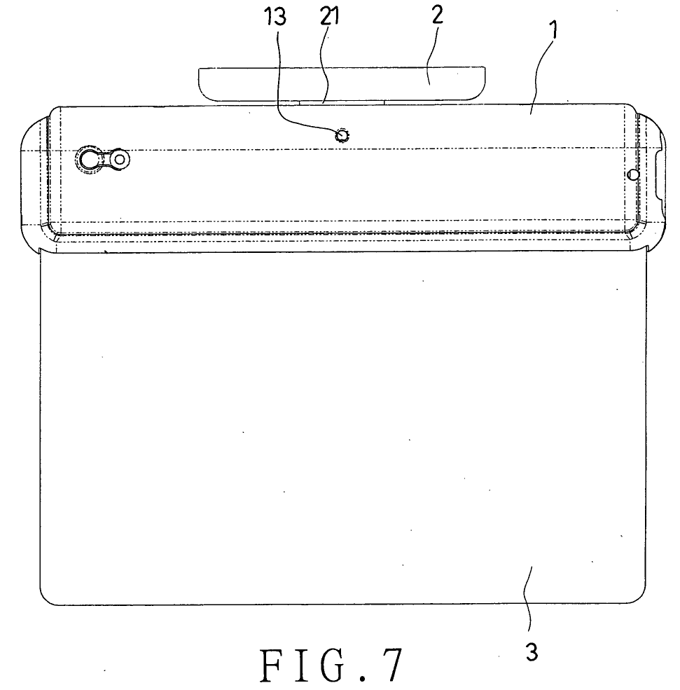

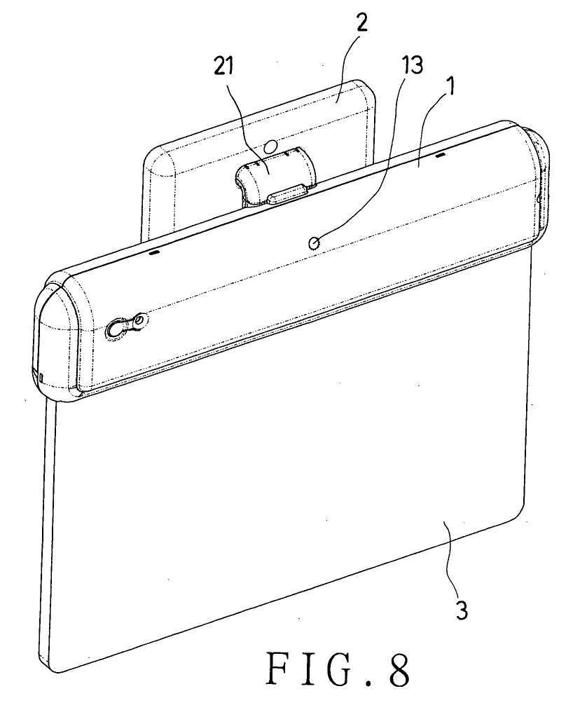

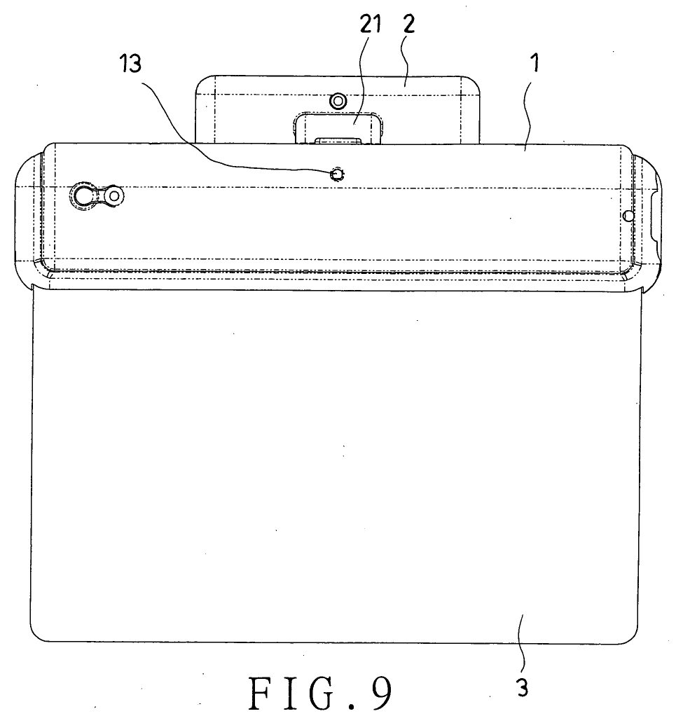

Referring to FIG. 7, a second preferred embodiment of the invention is provided, which has a hosing member 1, and a locating member 2 connected to an upper side of the housing member 1 such that the second preferred embodiment is suitable for use on another part of the building, e.g. the roof. Referring to FIGS. 8 and 9, a third preferred embodiment of the invention has a housing member 1, a sign panel 3 supported on the housing member 1, and a locating member 2, which has a curved fitting bar portion 21; the locating member 2 is joined to the housing member 1 in such a way that the sign panel 3 will be horizontal when the light and sign assembly is secured to a roof of a building at the locating member 2 thereof.

From the above description, it can be seen that when compared with the conventional light and sign assembly for showing the direction of an emergency exit, the light and sign assembly of the present invention takes less time, and is easier to install and assemble because the lamp will be automatically connected to the wires connected to the main supply of electricity as soon as the housing member is fitted on the fitting bar portion of the locating member at the fitting part. Therefore, the light and sign assembly of the present invention is more convenient to use.

What is claimed is:

1. A light and sign assembly for showing direction of an emergency exit, comprising
a housing member; the housing member having a first opening on a lower side; the housing member having a second opening; the housing member having a fitting part securely held therein; the fitting part being next to the second opening of the housing member;
a sign panel having figures and an arrow thereon for showing direction of an emergency exit; the sign panel being joined to the lower side of the housing member;
a plurality of lamps; the lamps being held in the housing member such that light from the lamps will travel to the sign panel through the first opening of the housing member;
a first terminal secured in the fitting part of the housing member and electrically connected to the lamps; and
a locating member secured on a part of a building; the locating member having a hollow fitting bar portion; the locating member having a second terminal held in the hollow fitting bar portion thereof, and electrically connected to a main supply of electricity;
the first and the second terminals being going to be connected for connecting the lamps to the main supply of electricity as soon as the housing member is fitted on the hollow fitting bar portion of the locating member at the second opening and the fitting part thereof.

2. The light and sign assembly as claimed in claim 1, wherein the housing member has an external through hole, and the fitting part in the housing member has an engaging hole facing the external through hole, and the locating member has a hooked portion on the hollow fitting bar portion thereof; the hooked portion of the locating member being going to pass through the engaging hole of the fitting part of the housing member to engage the fitting part when the housing member is fitted on the hollow fitting bar portion of the locating member at the second opening and the fitting part thereof; the hooked portion being going to disengage the fitting part when a stick-shaped tool is passed through the external through hole of the housing member and pressed against the hooked portion.

3. The light and sign assembly as claimed in claim 1, wherein the second opening of the housing member is in such a position that the locating member is on a lateral side of the housing member.

4. The light and sign assembly as claimed in claim 1, wherein the second opening of the housing member is in such a position that the locating member will be on top of the housing member when the housing member and the locating member are joined.

5. The light and sign assembly as claimed in claim 1, wherein the hollow fitting bar portion of the locating member is curved, and the locating member is joined to the housing member and secured in position in such a way that the sign panel is horizontal.
